(19) United States
(12) Patent Application Publication
(10) Pub. No.: US 2008/0260417 A1
(43) Pub. Date: Oct. 23, 2008

(54) CHARGING DEVICE AND IMAGE FORMING APPARATUS HAVING THE SAME

(75) Inventor: Tomoya Hotani, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/104,762

(22) Filed: Apr. 17, 2008

(30) Foreign Application Priority Data
Apr. 20, 2007 (JP) 2007-111210

(51) Int. Cl. G03G 15/02

(52) U.S. Cl. 399/100; 399/171

(57) ABSTRACT

A charging device (37) includes a discharge wire (85) to which a charging bias is applied, a box-like shield (84) surrounding the discharge wire (85) and having an opening (86) the body surface, a grid (87) mounted to the opening (86) and applied with a grid voltage, a moving base (94) movable along the discharge wire (85), a drive unit (95) for moving the moving base (94), and a cleaning member (96) mounted on the moving base (94) to clean a surface of the grid (87) facing the discharge wire (85) in accordance with movement of the moving base (94). The cleaning member (96) is provided with a plurality of bristles (K) each having an end that is so formed as to have a loop-like shape. The loop-like end comes in contact with the grid surface facing the discharge wire (85).

### BACKGROUND OF THE INVENTION

1. Field of the Invention

The present invention relates to a charging device provided with a cleaning member for cleaning a grid, and an image forming apparatus having the charging device.

2. Description of the Related Art

A charging device of a scorotron type for charging a photosensitive drum (a body to be charged) used in an image forming apparatus such as a printer and a copying machine has been known. The scorotron type charging device includes a metal shield having a substantially U-shaped cross-section and an opening facing an outer peripheral surface of the photosensitive drum. There is provided a discharge wire inside the shield, and a grid (grid electrode) in the opening. The outer peripheral surface of the photosensitive drum is uniformly charged at a desired electric potential by application of a predetermined voltage to the discharge wire and the grid.

In such charging device, unevenness in electric charge and lowering in electric potential (hereinafter, referred to as “charge unevenness”) occur on the photosensitive drum if the grid is contaminated by adhered object such as toners, charge generating object and dusts. Performing image forming in this state causes, for example, unevenness in density of an image, so that image quality is lowered.

For the purpose of preventing the above-described charge unevenness, it is necessary to clean the grid. The grid may be wire-like or mesh-like. As a technology of cleaning a mesh-like grid, the Japanese Laid-open Patent Publication No. 2006-91456 discloses cleaning of a grid with a brush provided with a plurality of brush bristles. According to this Patent Publication, the thickness of the grid, a distance between a brush surface on which brush bristles are provided and the grid, a slope angle of the brush bristles with respect to the grid are set to clean the grid.

However, according to the Patent Publication, each of the brush bristles provided on the brush surface extends linearly like a normal brush. Accordingly, if the brush is moved along a discharge wire while bringing ends of the brush bristles into contact with the grid, contact portions of the ends of the brush bristles with the grid are oriented toward a downstream side with respect to the moving direction of the brush (in other words, oriented in a direction opposite to the moving direction). Therefore, it becomes likely that a gap is formed between the brush bristles and also that if an object adhering to the grid has a strong adherence, the brush bristles are forced to move along a surface of the object without removing the object. As a result, unevenness in cleaning the grid becomes likely to occur.

### SUMMARY OF THE INVENTION

In view of this, an object of the present invention is to provide a charging device having a cleaning member which reduces unevenness in cleaning the grid, and an image forming apparatus having the same.

In order to accomplish the foregoing object of the present invention, there is provided in accordance with the present invention a charging device which is arranged opposed to a surface of a body to charge the body surface. The charging device includes a discharge wire to which a charging bias is applied, a box-like shield surrounding the discharge wire and having an opening facing the surface of the body, a grid provided in the opening and applied with a grid voltage, a moving base movable along the discharge wire, a drive unit for moving the moving base, a cleaning member mounted on the moving base to clean a surface of the grid facing the discharge wire in accordance with movement of the moving base. The cleaning member is provided with a plurality of bristles each having an end that is so formed as to have a loop-like shape. The loop-like end comes in contact with the grid surface facing the discharge wire.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a perspective view of an image forming apparatus, viewed from a front left side and diagonally from above.

FIG. 2 is a perspective view of the image forming apparatus, viewed from a rear left side and diagonally from above.

FIG. 3 schematically shows an internal configuration of the image forming apparatus, viewed from a left side.

FIG. 4 shows a drum unit having a photosensitive drum, a charging device and a drum cleaner, viewed from a front side.

FIG. 5 shows the drum unit, viewed from a right side.

FIG. 6 is a perspective view showing the charging device, viewed from a front right side and from diagonally above.

FIG. 7 is a front view of the charging device.

FIG. 8 is a front view of the charging device of FIG. 7 with a left support block, a right support block and a shield detached therefrom.

FIG. 9 is a cross-sectional view taken along the line A-A of FIG. 8.

FIG. 10 shows a state where a moving base of the charging device moves to a cleaning start position and a turning-back position.

FIG. 11 is a cross-sectional view taken along the line B-B of FIG. 10.

FIG. 12 shows an operation of a cleaning member of the charging device.

FIGS. 13A through 13F show deformation of bristles of the cleaning member.

### DETAILED DESCRIPTION OF THE PREFERRED EMBODIMENTS

Hereinafter, preferred embodiments of the present invention will be described in detail with reference to the drawings. In the drawings, members and parts identified with the same reference numerals have the same configuration, and duplicated description regarding those will be omitted appropriately. Further, in the drawings, depiction of the members and parts which are not relevant for description will be omitted.

### Embodiment 1

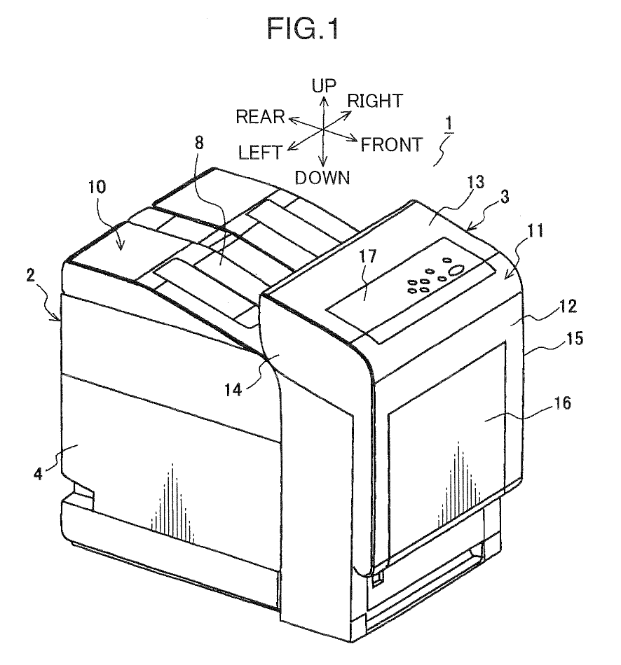

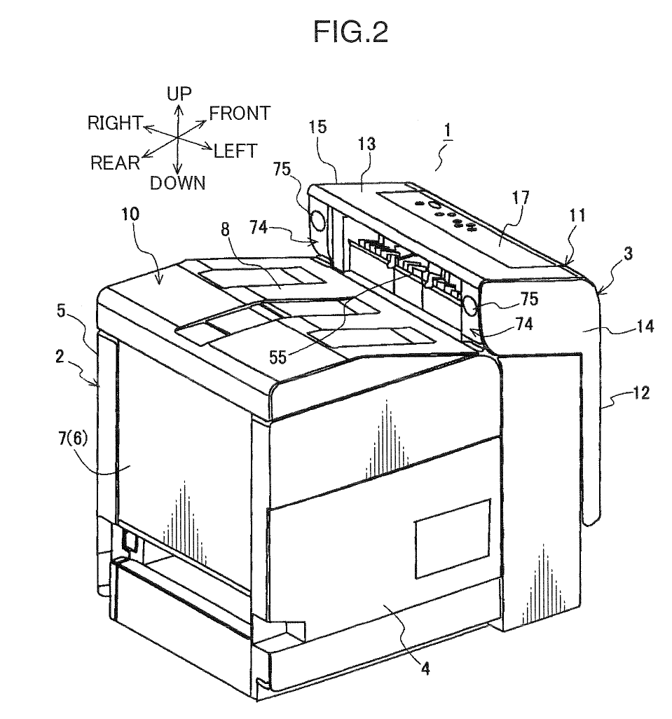

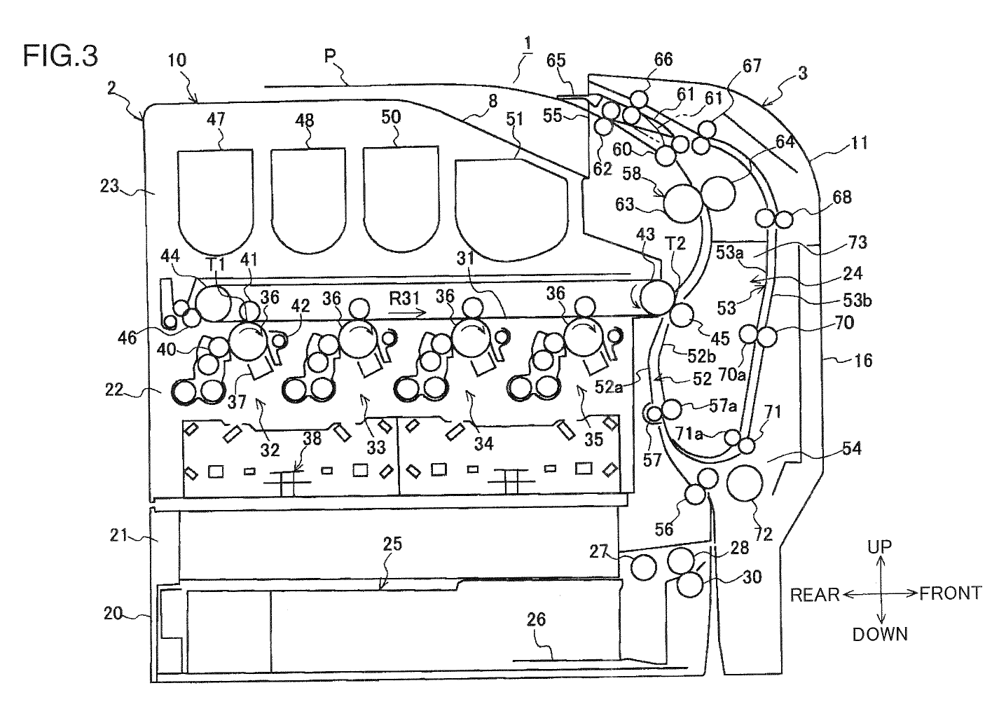

An image forming apparatus 1 having a charging device 37 in accordance with the present invention will be described with reference to FIGS. 1 through 3. In FIGS. 1 through FIG. 3, a vertical direction, a front and rear direction, and a left and right direction in the image forming apparatus 1 are indicated by arrows. FIG. 1 is a perspective view of the image forming apparatus 1 in its entity, viewed from a front left side and from diagonally above. FIG. 2 is a perspective view of the image forming apparatus 1, viewed from a rear left side and diagonally from above. Furthermore, FIG. 3 schematically shows an internal configuration of the image forming apparatus 1, viewed from the left side.

The image forming apparatus 1 may be a printer, a copying machine, a facsimile machine, or a complex machine having functions of those. However, in the description herebelow, the image forming apparatus 1 will be described as a printer. The image forming apparatus 1 shown in FIGS. 1 through 3 is a four full-color image forming apparatus adopting an electrophotographic method, an intermediate transfer method and a tandem method.

With reference to FIGS. 1 and 2, the configuration of the image forming apparatus 1 viewed from outside will be described. The image forming apparatus 1 includes a substantially box-shaped (cuboid-shaped) apparatus main body 2, and a front cover 3 which is openably and closeably supported by the apparatus main body 2.

The apparatus main body 2 has a front face covered with the front cover 3, and a left face and a right face covered respectively with a left outer panel 4 and a right outer panel 5 made of synthetic resin. From a rear face of the apparatus main body 2, a part of a metal plate constituting a main body frame 6 of the apparatus main body 2 is exposed. The apparatus main body 2 has a top face covered at a front portion thereof with the front cover 3. An intermediate portion and a rear portion of the top face are covered with a sheet discharge tray 10 having a sheet-holding surface 8 which slopes upward and rearward.

The front cover 3 includes a front outer panel 11 and a part of a sheet conveying section 24 (FIG. 3) which is provided inside the front outer panel 11. The front outer panel 11 includes a front panel 12, an upper panel 13 sloping upward and rearward from an upper end of the front panel 12, and a left panel 14 and a right panel 15 both having an inversed L-shape, all of which are formed integrally. The front panel 12 is provided with a manual sheet feeding tray 16 having a rectangular shape. The manual sheet feeding tray 16 is so configured that its lower end is swingable with respect to the apparatus main body 2. The manual sheet feeding tray 16 forms a part of the front panel 12 in a closed state, and becomes a sheet holder holding sheets on its top surface in an opened state (not illustrated) where an upper end portion of the front panel 12 is drawn forward. The upper panel 13 is provided with an operation panel (operating section) 17. The operation panel 17 is so positioned that a rear end side of the operation panel 17 slopes to be slightly higher than a front end side, so that an operator (for example, a user) who stands in front of the image forming apparatus 1 to perform operation can easily look at the operation panel 17. The operation panel 17 is provided with a liquid crystal display section of a touch panel type and various buttons, so that an operator can perform the operation of the image forming apparatus 1 through the operation panel 17 standing in front of the image forming apparatus 1. The left panel 14 and the right panel 15 are so provided as to cover a part of the sheet conveying section 24, arranged inside the front cover 3, from the left side and the right side.

The front cover 3 is swingably supported at its lower end by the apparatus main body 2. Accordingly, the front cover 3 is openable and closeable with respect to the apparatus main body 2. As shown in FIG. 2, releasing levers (releasing members) 74 for opening the front cover 3 are provided, respectively, on an inner surface of the left panel 14 at an upper and rear portion thereof, and on an inner surface of the right panel 15 at an upper and rear portion thereof. Each of the releasing levers 74 has a button 75 arranged in an upper end thereof. When the button 75 is pushed in the front direction, a locking member (not illustrated) supported by the front cover 3 and engaged with the apparatus main body 2 is released. Accordingly, the front cover 3 can be opened. When the front cover 3 is opened, an operator can solve a sheet jam by removing a jammed sheet. The sheet-feeding cassette 25 (FIG. 3) accommodating sheets subjected to image forming can be inserted into and detached from the image forming apparatus 1 from the front side of the image forming apparatus 1. An operator can perform from the front side of the image forming apparatus 1 overall operation of the image forming apparatus 1 through the operation panel 17, the jam processing and the supply of sheets to the sheet-feeding cassette 25.

Description regarding the external configuration of the image forming apparatus 1 viewed from outside ends here.

Next, the internal configuration of the image forming apparatus 1 will be described with reference to FIG. 3. The image forming apparatus 1 is provided with a sheet-accommodating section 20, a board-accommodating section 21, an image forming section 22, a toner supplying section 23 and a sheet discharge tray 10, in the order from the lower side to the upper side of the apparatus main body 2. The sheet conveying section 24 is provided between the front portion of the apparatus main body 2 and the front cover 3.

The sheet-feeding cassette 25 is arranged in the sheet-accommodating section 20. The sheet-feeding cassette 25 accommodates a plurality of sheets in a stacked state, and leading end portions (right end portions in FIG. 3) of the stacked sheets are urged upward by a lifting plate 26 provided on a bottom of the sheet-feeding cassette 25. Accordingly, a topmost one of the stacked sheets in the sheet-feeding cassette 25 is picked up and conveyed by a pickup roller 27 of the sheet conveying section 24. Multi-feeding of the sheets is prevented by a conveying roller 28 and a retard roller 30 of the sheet conveying section 24, so that only one sheet is fed to a downstream side. The board-accommodating section 21 is provided above the sheet-feeding cassette 25.

The board-accommodating section 21 is provided with a board and electrical components for controlling the image forming apparatus 1. The image forming section 22 is provided above the board-accommodating section 21.

The image forming section 22 includes an intermediate transfer belt 31, and a yellow (Y) image forming station 32, a magenta (M) image forming station 33, a cyan (C) image forming station 34 and a black (Bk) image forming station 35 provided along a rotational direction (a direction of an arrow R31) of the intermediate transfer belt 31. The image forming stations 32 to 35 have substantially the same configuration. The yellow image forming station 32 includes a photosensitive drum (a body to be charged) 36, a charging device 37, a developing device 40, a primary transfer roller (transferring device) 41 and a drum cleaner 42 provided along a rotational direction (arrow direction) of the photosensitive drum 36. Below the image forming stations 32 to 35, there are provided corresponding exposing devices 38. Each photosensitive drum 36 is rotated in the arrow direction at a predetermined speed. An outer peripheral surface of the photosensitive drum 36 is uniformly charged at a predetermined polarity and electrical potential by the charging device 37. Thereafter, the outer peripheral surface of the photosensitive drum 36 is radiated with light by the exposing devices 38 based on image data transmitted from a personal computer (not illustrated) or the like to remove electric charges on the exposed portion of the outer peripheral surface, so that an electrostatic latent image is formed on the outer peripheral surface. The developing device 40 allows toners contained in developer to adhere to the electrostatic latent image, so that a toner image is formed. In the present embodiment, the developer is a two-component developer including toners and carriers.

The toner image formed on the outer peripheral surface of the photosensitive drum 36 is transferred to an outer surface of the intermediate transfer belt 31. The intermediate transfer belt 31 extends between the drive roller 43 and the driven roller 44 and rotates in a direction of an arrow R31 by rotation of the drive roller 43 in an arrow direction. The yellow toner image formed on the outer peripheral surface of the photosensitive drum 36 is transferred onto the intermediate transfer belt 31 by a primary transfer roller 41 at a primary transfer position T1. Toners (primary transfer remaining toners) remaining on the outer peripheral surface of the photosensitive drum 36 are removed by the drum cleaner 42 after the primary transfer of the toner image.

The image forming stations 33, 34, 35 for three colors (cyan, magenta, black) also have the same configuration as that of the yellow image forming station 32. Toner images of cyan, magenta, and black are formed respectively on outer peripheral surfaces of the photosensitive drums 36 of the image forming station 33, 34, 35 in the same manner. Then, the toner images of respective colors are sequentially transferred onto the outer surface of the intermediate transfer belt 31. In this way, the toner images of four colors are in superimposition on the intermediate transfer belt 31. The superimposed toner images of four colors formed on the intermediate transfer belt 31 are transferred to a sheet, which is conveyed by the sheet conveying section 24, at a secondary transfer position T2 by a secondary transfer roller 45. Toners (secondary transfer remaining toners) remaining on the outer surface of the intermediate transfer belt 31 after the secondary transfer of the toner images are removed by a belt cleaner 46 provided in the vicinity of the driven roller 44. The toner supplying section 23 is provided above the image forming section 22.

The toner supplying section 23 accommodates four toner containers 47, 48, 50, 51 respectively accommodating toners of yellow, magenta, cyan, and black. Each of the developing devices 40 is provided with a density sensor (not illustrated) for detecting the density (weight ratio of toners and developer) of toners of corresponding colors. When the density sensor detects that the amount of toner in the developing device 40 is smaller than a predetermined value, toners are supplied from the toner containers 47, 48, 50, 51 to the developing devices 40. The sheet discharge tray 10 is arranged above the toner supplying section 23.

The sheet discharge tray 10 is so formed as to cover the top face of the apparatus main body 2. A front portion of the sheet discharge tray 10 is formed to have a sloped surface while a rear portion of the sheet discharge tray 10 is formed to have a flat surface. Sheets discharged in the rear direction from a sheet-discharging exit 55 of the sheet conveying section 24 are stacked on the sheet holding surface 8 defined on the top surface of the sheet discharge tray 10.

In the present embodiment, the sheet conveying section 24 is provided between the front portion of the apparatus main body 2 and the front cover 3, and includes a sheet conveying passage 52 for guiding a sheet conveyed from the lower side to the upper side of the apparatus main body 2, a sheet reversing passage 53 provided on the front side of the sheet conveying passage 52 for guiding a sheet conveyed from the upper side to the lower side of the apparatus main body 2, and a manual feeding section 54.

The sheet conveying passage 52 extends upwards while curving gradually from the vicinity of the conveying roller 28, and passes between the drive roller 43 and the secondary transfer roller 45 and reaches the sheet-discharging exit 55. The sheet conveying passage 52 includes a rear guide rail 52a and a front guide rail 52b facing each other. The front guide rail 52b constitutes a part of a conveying unit 73. The sheet conveying passage 52 is provided with the pickup roller 27, the conveying roller 28, the retard roller 30, a pair of conveying passage rollers 56, a pair of registration rollers 57, the secondary transfer roller 45, a fixing section 58, a pair of conveying rollers 60, a switching flapper 61 and a pair of sheet-discharging rollers 62, from the lower side to the upper side of the apparatus main body 2. The fixing section 58 includes a fixing roller 63 having a built-in heater (not illustrated) and a pressing roller 64 that is arranged in contact with the fixing roller 63 to form a fixing nip therebetween.

A sheet which is fed by the pickup roller 27, the conveying roller 28 and the retard roller 30 from the sheet-feeding cassette 25 to the sheet conveying passage 52 is conveyed by the pair of conveying rollers 56 and the pair of registration rollers 57, and the toner images of four colors on the intermediate transfer belt 31 are transferred onto the sheet at the secondary transfer position T2. The sheet is heated and pressed when it passes through the fixing nip, so that the toner image is fixed on the sheet. The sheet on which the toner image is fixed is guided on the side of a lower surface of the switching flapper 61 by the pair of conveying rollers 60, and conveyed to the pair of sheet-discharging rollers 62. Next, the sheet is discharged from the sheet-discharging exit 55 by the pair of sheet-discharging rollers 62 in the rear direction, and stacked on the sheet holding surface 8 of the sheet discharge tray 10. FIG. 3 shows a state where a sensor flag 65 of a sheet discharge sensor arranged on the immediate downstream of the pair of sheet-discharging rollers 62 is operated by the sheet P being discharged.

The sheet reversing passage 53 is a conveying passage which extends in front of the sheet conveying passage 52 from the upper side to the lower side of the apparatus main body 2, and merges with the sheet conveying passage 52. The sheet reversing passage 53 includes a rear guide rail 53a and a front guide rail 53b, which are facing each other. The rear guide rail 53a form a part of the conveying unit 73. Further, a major part of the front guide rail 53b is mounted on an inner surface of the outer panel 11, and forms the front cover 3 together with the outer panel 11. The sheet reversing passage 53 is provided with a pair of reverse rollers 66, the switching flapper 61, first, second, third and fourth pairs of re-conveying rollers 67, 68, 70, 71, sequentially from the upper side defined as the upstream side at the time of reversing a sheet.

When images are to be formed on both sides of the sheet, the switching flapper 61 is switched to a position indicated by two-dotted chain lines, and a sheet on which a toner image is fixed on one side is conveyed from the pair of conveying rollers 60 toward the pair of reverse rollers 66 along an upper surface of the switching flapper 61. The sheet is conveyed by the rotation of the pair of reverse rollers 66 in the rear direction, and the pair of reverse rollers 66 are reversely rotated before the rear end portion of the sheet passes through the pair of reverse rollers 66. The reverse rotation of the pair of reverse rollers 66 allows the sheet to be conveyed back to the sheet conveying passage 52 by the first to fourth pairs of re-conveying rollers 67, 68, 70, 71. Then, a toner image is transferred and fixed on the other side of the sheet. The sheet is discharged through the sheet-discharging exit 55 in the rear direction, and stacked on the sheet holding surface 8 of the sheet discharge tray 10. The sheet conveying section 24 is provided with a manual feeding conveying roller 72 arranged on the front side of the pair of conveying rollers 56. A sheet set on the manual feeding tray 16 is conveyed toward the pair of conveying rollers 56 by the conveying roller 72.

A part of the sheet conveying section 24 forms a conveying unit 73. The conveying unit 73 includes the front guide rail 52b of the sheet conveying passage 52, the rear guide rail 53a of the sheet reversing passage 53, a roller 57a of the pair of registration rollers 57, the secondary transfer roller 45, and rollers 70a, 71a of the third and fourth pairs of re-conveying rollers 70, 71. When the front cover 3 is opened, the conveying unit 73 is exposed to the outside. In other words, a part of the sheet conveying passage 52 and a part of the sheet reversing passage 53 are exposed to the outside.

Description regarding the internal configuration of the image forming apparatus 1 ends here.

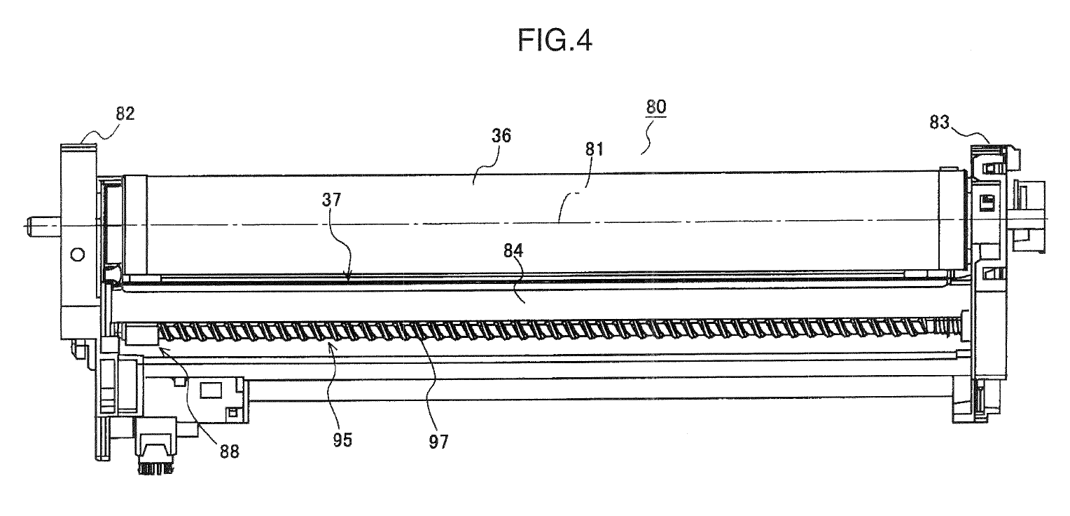

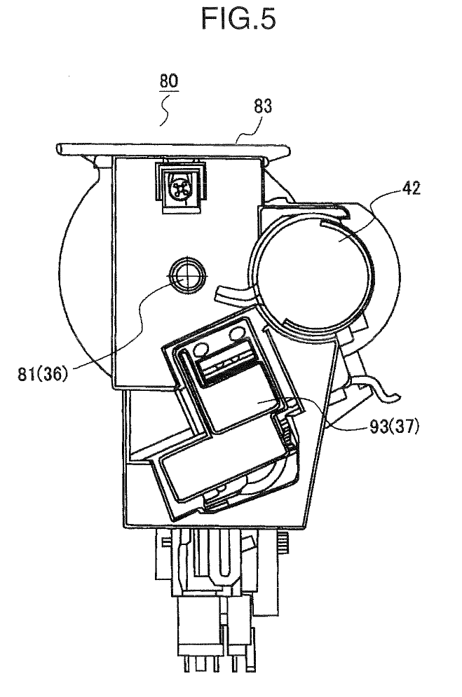

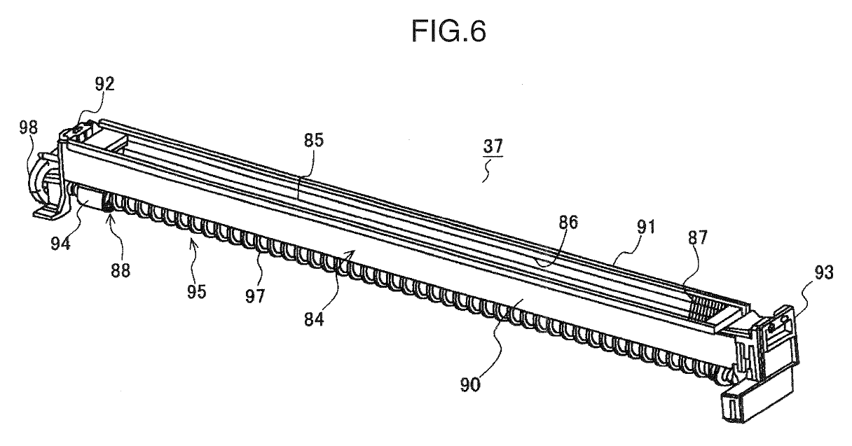

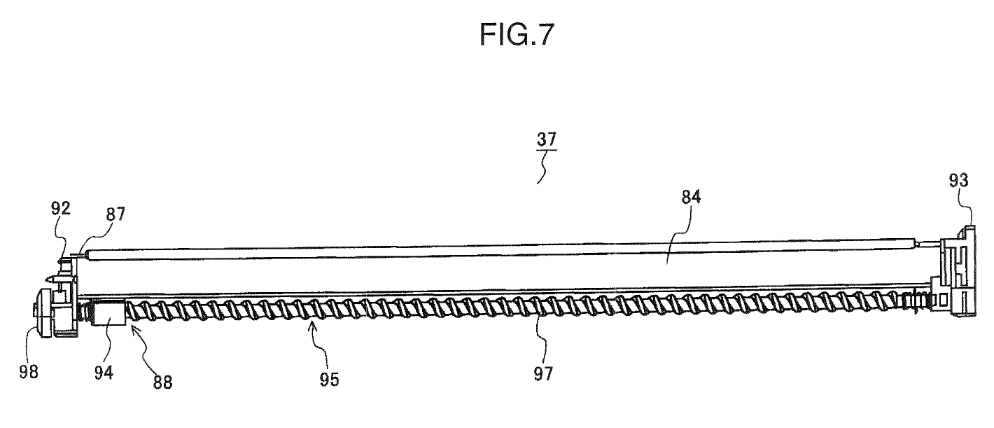

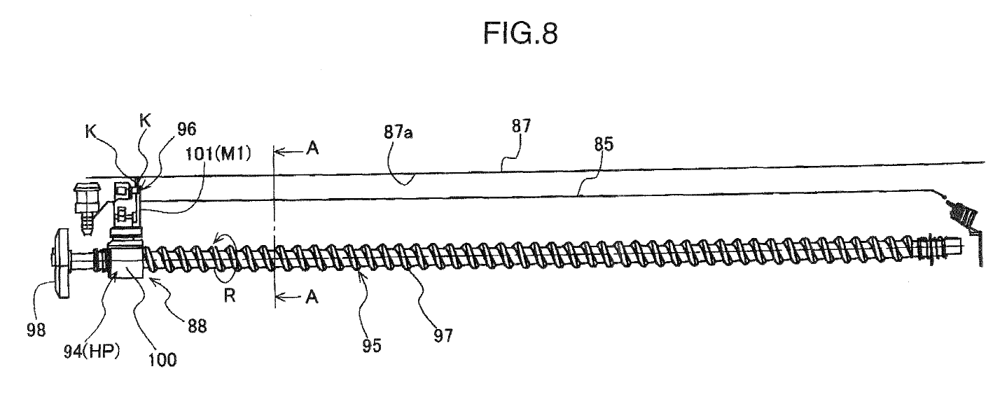

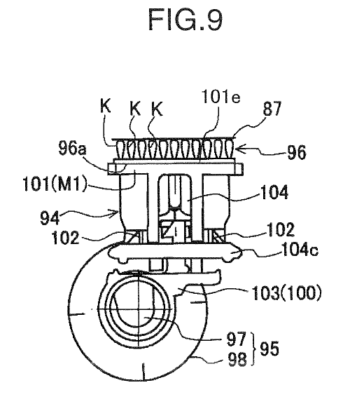

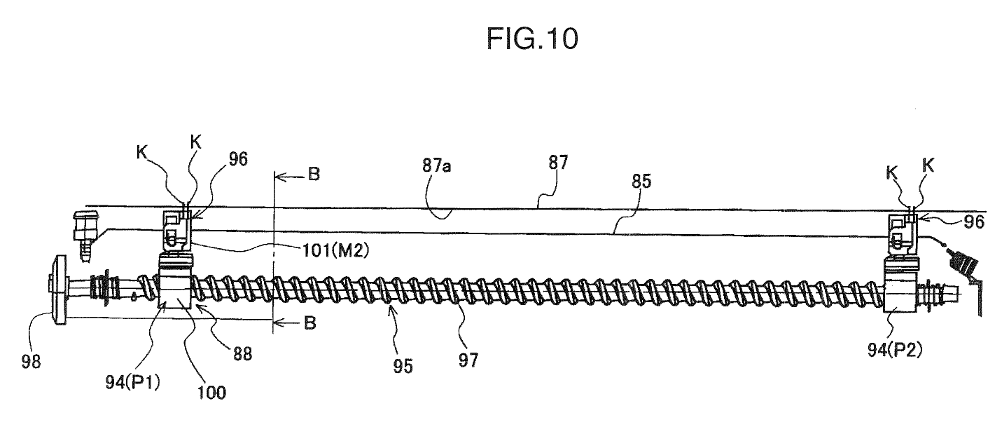

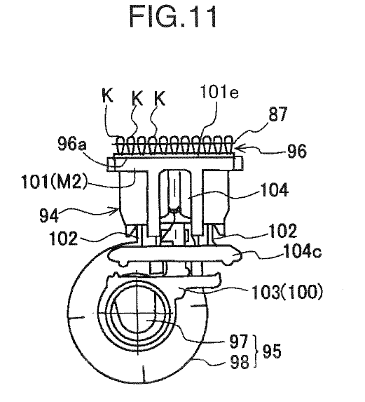

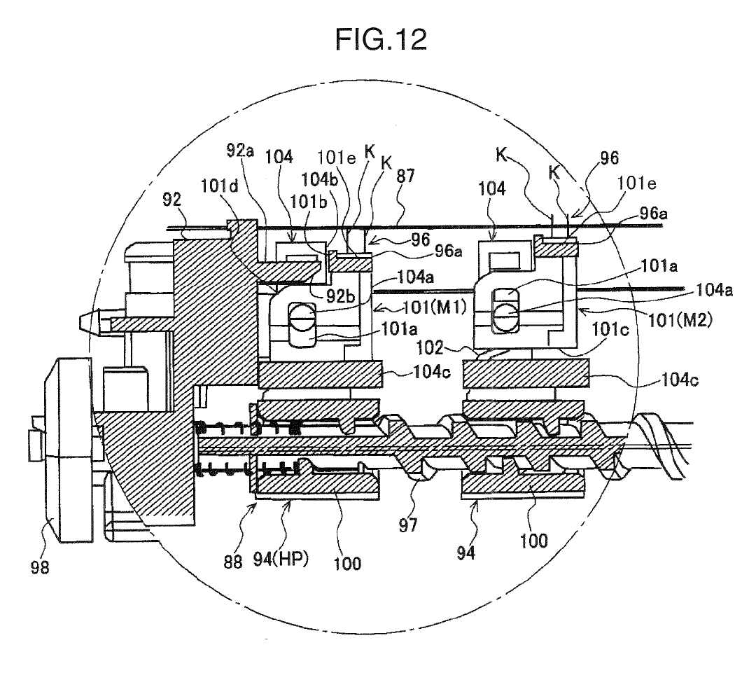

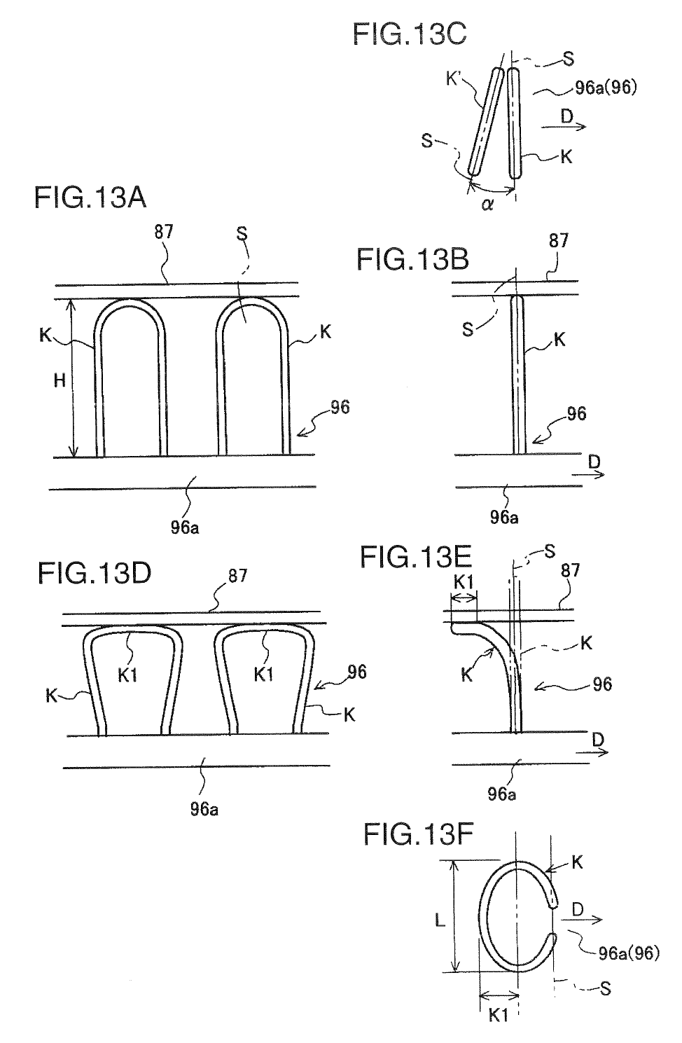

Next, the charging device 37 in accordance with the present invention will be described with reference to FIGS. 4 through 13. FIG. 4 shows a drum unit 80 having a photosensitive drum 36, the charging device 37 and a drum cleaner 42, viewed from a front side (right side in FIG. 3). FIG. 5 shows the drum unit 80, viewed from a right side. FIG. 6 is a perspective view showing the charging device 37, viewed from a front right side and from diagonally above. FIG. 7 is a front view of the charging device 37. FIG. 8 is a front view of the charging device with a left support block 92, a right support block 93 and a shield 84 detached from the charging device 37. FIG. 9 is a cross-sectional view taken along the line A-A of FIG. 8. FIG. 10 shows a state where a moving base 94 of the charging device 37 is moved to a cleaning start position P1 and a turning-back position P2. FIG. 11 is a cross-sectional view taken along the line B-B of FIG. 10. FIG. 12 shows an operation of a cleaning member 96 of the charging device 37. FIGS. 13A through 13F show deformation of bristles K of the cleaning member 96. In FIGS. 10, 11 and 12, for convenience in description, the bristles K of the cleaning member 96 are so depicted as to protrude upward past a grid 87. However, since the bristles K are deformed by the grid 87 as depicted in FIGS. 13D through 13F, they actually do not project upward past the grid 87.

As shown in FIGS. 4 and 5, the charging device 37 is so provided as to face the outer peripheral surface of the photosensitive drum 36 from diagonally below. The charging device 37 is so shaped as to extend in a left and right direction in FIG. 4, and has its longitudinal axis that is so set as to extend along a center axis 81 of the photosensitive drum 36 (or along a generating line of the surface of the photosensitive drum 36). As shown in FIG. 6, the grid 87 provided in an opening 86 of a shield 84 of the charging device 37 is so positioned as to face the outer peripheral surface of the photosensitive drum 36 at a predetermined gap (for example, about 1 mm). Left ends and right ends of the photosensitive drum 36, the charging device 37 and the drum cleaner 42 are supported by a left holder 82 and a right holder 83.

As shown in FIG. 6, the charging device 37 includes the shield 84 so formed as to have a rectangular box-like shape extending in the left and right direction, a discharge wire (charging wire) 85 arranged inside the shield 84, a grid (grid electrode) 87 mounted to the opening 86 of the shield 84, and a cleaning mechanism 88 for cleaning the discharge wire 85 and the grid 87. The shield 84 has a front plate 90, a rear plate 91 facing the front plate 90, and a bottom plate (not illustrated) arranged between a lower end of the front plate 90 and a lower end of the rear plate 91. The opening 86 is formed between an upper end of the front plate 90 and an upper end of the rear plate 91 to face in an upward direction in FIG. 6 the outer peripheral surface of the photosensitive drum 36. The grid 87 extends between the upper ends of the front plate 90 and the rear plate 91. The shield 84 is made of metal plates, and has left end and right end supported respectively by a left supporting block 92 and a right supporting block 93. As shown in FIG. 6, the discharge wire 85 is positioned under the opening 86 of the shield 84 to extend in the longitudinal direction of the shield 84. The grid 87 is actually arranged to cover the entire opening 86 of the shield 84. However, in FIG. 6, only a part of the grid 87 is shown to be arranged on the right end of the opening 86 of the shield 84, and the remaining part of the grid 87 is omitted. In the present embodiment, the grid 87 has a mesh-like configuration in which thin plates having a small width are aligned in the longitudinal direction of the shield 84 and between the upper end of the front plate 90 and the upper end of the rear plate 91 with slits formed between the neighboring thin plates while each plate is inclined about thirty degrees with respect to the front and rear direction perpendicular to the longitudinal direction of the shield 84. The discharge wire 85 is made of tungsten, and the grid 87 is made of, for example, stainless steel or the like.

In the charging device 37, a voltage of about 2 kilovolts is applied to the discharge wire 85, and a voltage of about hundreds of volts is applied to the grid 87, when image forming is performed. This uniformly charges the entire outer peripheral surface of the photosensitive drum 36 at electric potential which is nearly the same as that of the grid 87.

The discharge wire 85 and the grid 87 of the charging device 37 are contaminated by adhered objects such as toners, charge generating object and dusts when the number of sheets subjected to image forming increases, in other words, when the charging process is performed consecutively. If such adhered objects are not removed, the charged potential at the outer peripheral surface of the photosensitive drum 36 is lowered, so that a desirable charged potential may not be obtained at the outer peripheral surface of the photosensitive drum 36, or unevenness in the charged potential may occur at the outer peripheral surface of the photosensitive drum 36. Therefore, for the purpose of preventing the unevenness in charge, the adhered objects are removed by the cleaning mechanism 88 in such a manner as described herebelow.

As shown in FIGS. 7, 8, and 10, the cleaning mechanism 88 includes a moving base 94 which is movable along the discharge wire 85, a drive unit 95 for moving the moving base 94, and a cleaning member 96 mounted on the moving base 94 for cleaning a face 87a of the grid 87 facing the discharge wire 85 along with movement of the moving base 94.

As shown in FIG. 7, the drive unit 95 includes a screw 97 and a drive gear 98. The screw 97 is provided under the shield 84 to extend in the longitudinal direction of the shield 84. The screw 97 has a left end rotatably supported by a left support block 92 and a right end rotatably supported by a right support block 93. The drive gear 98 is fixed to a left end of the screw 97, and is rotationally driven by a drive motor (not illustrated) provided in the apparatus main body 2 (FIG. 3).

As shown in FIGS. 9, 11, and 12, the moving base 94 includes a moving base main body 100, a mounting base 101 and a spring member 102 interposed between the moving base main body 100 and the mounting base 101. The moving base main body 100 includes an engagement body 103 engaged with the screw 97, and a wire cleaner 104 integrally so formed with the engagement body 103 as to be positioned inside the shield 84. The wire cleaner 104 is operable to sandwich the discharge wire 85 from front and rear sides to clean the discharge wire 85. The mounting base 101 is supported by the wire cleaner 104 so as to be movable upward and downward. As shown in FIG. 12, the mounting base 101 has a vertically elongated engagement window 101a in which a guide pin 104a projecting from the wire cleaner 104 is engaged, and also has an elevatable guide surface 101b guided by a right side face 104b of the wire cleaner 104. The spring member 102 is interposed between a lower surface 101c of the mounting base 101 and a part 104c of the wire cleaner 104 to urge upward the mounting base 101 toward the grid 87 positioned above the mounting base 101. The guide pin 104a serves as a stopper for restricting the upward movement of the mounting base 101 by coming into contact with a lower edge of the engagement window 101a. The mounting base 101 has a left end formed at its top with a sloped surface 101d. The mounting base 101 is pushed downward through the sloped surface 101d by an inclined surface 92b of a retreating member 92a projecting rightwardly from the left support block 92. When the moving base 94 moves from right to left and comes to a home position HP shown in FIG. 12, the mounting base 101 is positioned at a retreated position M1 against a biasing force of the spring member 102. On the other hand, when the moving base 94 moves rightward from the home position HP, the mounting base 101 is released from the retreating member 92a and is then urged upward by the spring member 102 to be positioned at a cleaning position M2.

As shown in FIGS. 9, 11, and 12, the mounting base 101 has a top surface defined as a mounting surface 101e on which the cleaning member 96 is mounted. The cleaning member 96 includes a plate-like base member 96a and a plurality of bristles K so attached to the base member 96a as to project upward. As shown in FIG. 13A, each of the bristles K has opposite ends fixed to the base member 96a in such a manner that an intermediate portion of the bristle K can have a loop-like shape. Hereinafter, the intermediate portion will be described as an end of the bristle K. The bristle K may be formed of a string made of synthetic fiber such as nylon and polyester. FIG. 13B shows the bristle K of FIG. 13A, viewed from the right side. FIG. 13C shows the bristle K of FIG. 13B, viewed from above. In FIGS. 13A through 13C, when it is provided that an imaginary plane defined by the bristle K having the loop-like end is identified by a reference sign S, in the present embodiment, the bristle K is attached on the base member 96a so that the imaginary plane S becomes perpendicular to a moving direction D of the cleaning member 96.

The thickness of the bristle K is so set that when the bristle K is pressed against the grid 87 to make the height of the bristle K one-third or one-half of the original height, the loop-like end of the bristle K can be elastically deformed and the deformed end can come into linear (including straight line and curved line) contact with the grid 87, not into point contact with the grid 87, and extend a predetermined distance on the grid 87. In other words, the elasticity of the bristle K is so set that when the loop-like end of the bristle K is pressed against the grid 87, the loop-like end can come into linear contact with the grid 87 and extend a predetermined distance on the grid 87. FIGS. 13D through 13F show a contact portion K1 of the loop-like end of the bristle K which is formed by bringing the end of the bristle K into linear contact with the grid 87. In the present embodiment, as shown in FIGS. 13D, 13E, and 13F, since the imaginary plane S is oriented in the direction perpendicular to the moving direction of the cleaning member 96, an effective contact portion L can be secured to have sufficient length. Herein, the effective contact portion L indicates a part of the linear contact portion K1 extending in a direction (width direction of the grid 87) perpendicular to the moving direction D of the cleaning member 96. The height H of the bristle K is, for example, about 3 mm, and the elasticity of the bristle K is so set that the height H of the bristle K becomes smaller by, for example, about 1-2 mm when the bristle K is pressed against the grid 87. In this case, the distance of movement of the mounting base 101 from the retreated position M1 to the cleaning position M2 (FIG. 9) is also set to be about 1 to 2 mm. The cleaning member 96 may be, for example, a commonly used hook-and-loop fastener instead of the bristles K. In this case, a loop portion of the hook-and-loop fastener is attached to the attachment surface 101e of the mounting base 101 with use of, for example, a double-sided tape.

In the charging device 37, cleaning of the discharge wire 85 and the grid 87 is performed at each time when image forming is carried out for, for example, 3000 or 5000 sheets. When cleaning is not performed, the moving base 94 waits at the home position HP shown in FIG. 8. At this time, the mounting base 101 is positioned at the retreated position M1. Accordingly, the end of the bristle K of the cleaning member 96 is not in contact with the grid 87. Even in the case where the end of the bristle K is in contact with the grid 87, it is held in slight contact with the grid 87 such that the bristle K and the grid 87 are not deformed. If the bristle K of the cleaning member 96 is always in contact with the grid 87, the bristle K may be elastically deformed so that its elasticity is lowered, or the grid 87 is deformed causing the gap between the grid 87 and the photosensitive drum 36 to change in size in the longitudinal direction of the grid 87, resulting in the unevenness in charged potential at the outer peripheral surface of the photosensitive drum 36.

When the drive motor of the apparatus main body 2 rotates the screw 97 in a direction of an arrow R (FIG. 8) through the drive gear 98, the moving base 94 is moved rightward to be positioned at the cleaning start position P1 shown in FIG. 10. Along with this, the mounting base 101 is moved apart from the retreating member 92a, and is urged by the spring member 102 to be positioned at the cleaning position M2 shown in FIG. 10. Accordingly, as shown in FIGS. 13D and 13E, the loop-like end of the bristle K of the cleaning member 96 is elastically deformed by the grid 87 to form the stiff linear contact portion K1. In this state, when the screw 97 is further rotated in the direction of the arrow R, the contact portion K1 moves rightward while slide-rubbing the grid 87. At this time, since the bristle K forms the effective contact portion L, adhered objects on the grid 87 can be wiped off in wide range in the width direction of the grid 87 by the effective contact portion L, compared with brush bristles having a straight-line shape. Further, even adhered objects which adhere strongly to the grid 87 can be scratched off by the effective contact portion L. Accordingly, adhered objects which can be hardly removed by the conventional brush bristles can be removed assuredly by the effective contact portion L.

When the moving base 94 reaches the turning-back position P2 shown in FIG. 10, the screw 97 is reversely rotated. Accordingly, the moving base 94 moves leftward. In this return path, similarly to the case of the outward path, adhered objects on the grid 87 can be removed. When the moving base 94 comes close to the home position HP, the mounting base 101 is retreated to the retreated position M2, and further the moving base 94 moves back to the home position HP. Accordingly, the screw 97 stops its rotation.

In the embodiment above, it is described that the imaginary plane S defined by the loop-like end is a plane perpendicular to the moving direction D of the cleaning member 96. However, the present invention is not limited to this configuration. For example, as shown in FIG. 13C, a bristle K′ may be so arranged that the imaginary plane S can have an inclined angle α relative to the direction perpendicular to the moving direction D. However, the inclined angle α should be 0<α<90 degrees. Even in this case, when the end of the bristle K′ is pressed against the grid 87, the end is deformed, and the linear contact portion K1 is formed, so that the effective contact portion L can be secured. However, as the slope angle α becomes larger, the effective contact portion L becomes smaller.

When it is provided that an area of the grid 87 subjected to cleaning has a length extending in a direction perpendicular to the moving direction of the moving base 94, which length is defined as a cleaning width, adhered objects on the grid 87 can be removed over the entire cleaning width if a plurality of effective contact portions L formed by loop-like ends of a plurality of bristles K are positioned to extend over the entire cleaning width. In this case, according to the present invention, the linear contact portion K1 and hence the effective contact portion L are formed, so that the density of the bristles K can be lowered as compared with a common brush in which a plurality of straight bristles are attached as a cleaning member.

In the above, the present invention has been described as applied to the cleaning member for cleaning the grid 87 of the charging device 37. However, the present invention may be applied to a cleaning member for wiping off adhered objects adhered to a common flat surface.

The above-described embodiment mainly includes the invention having the following configurations.

A charging device which is arranged opposed to a surface of a body to charge the body surface includes a discharge wire to which a charging bias is applied, a box-like shield surrounding the discharge wire and having an opening facing the surface of the body, a grid provided in the opening and applied with a grid voltage, a moving base movable along the discharge wire, a drive unit for moving the moving base, and a cleaning member mounted on the moving base to clean a surface of the grid facing the discharge wire in accordance with movement of the moving base. The cleaning member is provided with a plurality of bristles each having an end that is so formed as to have a loop-like shape. The loop-like end comes in contact with the grid surface facing the discharge wire.

According to the charging device, since the end of each bristle is formed to have a loop-like shape, the range of contact between the bristle and the grid can be made large as compared with the conventional bristle formed to have a linear shape. Accordingly, unevenness in cleaning the grid can be reduced. Further, the loop-like end can scrape off the strongly adhered objects.

In the above-described configuration, the loop-like end is deformed by the contact with the grid surface to form a linear contact portion on the grid surface. According to this configuration, the loop-like end forms a linear contact portion when in contact with the grid. Accordingly, as compared with the conventional bristle having a straight line shape, the range of contact between the bristle and the grid can be made large. Accordingly, unevenness in cleaning the grid can be further reduced.

In the above-described configuration, when the loop-like end is positioned away from the grid, the loop-like end forms an imaginary plane perpendicular to a direction in which the moving base moves. According to this configuration, the range of contact between the loop-like end of the bristle and the grid can be sufficiently secured in a direction perpendicular to the moving direction of the moving base.

In the above-described configuration, a part of the linear contact portion extending in a direction perpendicular to the moving direction of the moving base is defined as an effective contact portion, and an area of the grid surface to be cleaned has a length extending in a direction perpendicular to the moving direction of the moving base, which length is defined as a cleaning width. A plurality of the effective contact portions configured by a plurality of the loop-like ends is formed in the entire cleaning width. According to this configuration, the entire area of the grid subjected to cleaning can be cleaned without any unevenness.

In the above-described configuration, when the moving base is moved to a home position corresponding to one end of the discharge wire, the moving base is positioned away from the grid so that the loop-like end is positioned away from or in point contact with the grid. According to this configuration, the bristle is held in non-contact with the grid when not cleaning the grid. Accordingly, as compared with the configuration in which the bristle is always in contact with the grid, lowering in elasticity of the bristle and occurrence of elastic deformation of the bristle can be prevented.

The charging device in accordance with the present invention may be adopted in an image forming apparatus. The charging device allows the surface of the photosensitive member of the image forming apparatus to be charged uniformly. Accordingly, quality of image formed on a sheet can be secured.

This application is based on Japanese Patent Application No. 2007-111210 filed in Japan Patent Office on Apr. 20, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A charging device arranged opposed to a surface of a body to charge the body surface, the charging device comprising:
a discharge wire to which a charging bias is applied;
a box-like shield surrounding the discharge wire and having an opening facing the surface of the body;
a grid provided in the opening and applied with a grid voltage;
a moving base movable along the discharge wire;
a drive unit for moving the moving base;
a cleaning member mounted on the moving base to clean a surface of the grid facing the discharge wire in accordance with movement of the moving base;
wherein the cleaning member is provided with a plurality of bristles each having an end that is so formed as to have a loop-like shape; and
wherein the loop-like end comes in contact with the grid surface facing the discharge wire.

2. The charging device according to claim 1, wherein the loop-like end is deformed by the contact with the grid surface to form a linear contact portion on the grid surface.

3. The charging device according to claim 2, wherein when the loop-like end is positioned away from the grid, the loop-like end forms an imaginary plane perpendicular to a direction in which the moving base moves.

4. The charging device according to claim 3, wherein a part of the linear contact portion extending in a direction perpendicular to the moving direction of the moving base is defined as an effective contact portion, and an area of the grid surface to be cleaned has a length extending in a direction perpendicular to the moving direction of the moving base, which length is defined as a cleaning width; and
wherein a plurality of the effective contact portions configured by a plurality of the loop-like ends are formed in the entire cleaning width.

5. The charging device according to claim 1, wherein when the moving base is moved to a home position corresponding to one end of the discharge wire, the moving base is positioned away from the grid so that the loop-like end is positioned away from or in point contact with the grid.

6. An image forming apparatus comprising:
a photosensitive member as a body to be charged;
a charging device for charging a surface of the photosensitive member;
an exposure device for radiating a light to the charged surface of the photosensitive member to form an electrostatic latent image on the surface;
a developing device for developing the electrostatic latent image to form a toner image; and
a transferring device for transferring the toner image onto a sheet;
the charging device including:
a discharge wire to which a charging bias is applied;
a box-like shield surrounding the discharge wire and having an opening facing the surface of the photosensitive member;
a grid provided in the opening and applied with a grid voltage;
a moving base movable along the discharge wire;
a drive unit for moving the moving base;
a cleaning member mounted on the moving base to clean a surface of the grid facing the discharge wire in accordance with movement of the moving base;
wherein the cleaning member is provided with a plurality of bristles each having an end that is so formed as to have a loop-like shape; and
wherein the loop-like end comes in contact with the grid surface facing the discharge wire.

7. The image forming apparatus according to claim 6, wherein the loop-like end is deformed by the contact with the grid surface to form a linear contact portion on the grid surface.

8. The image forming apparatus according to claim 7, wherein when the loop-like end is positioned away from the grid, the loop-like end forms an imaginary plane perpendicular to a direction in which the moving base moves.

9. The image forming apparatus according to claim 8, wherein a part of the linear contact portion extending in a direction perpendicular to the moving direction of the moving base is defined as an effective contact portion, and an area of the grid surface to be cleaned has a length extending in a direction perpendicular to the moving direction of the moving base, which length is defined as a cleaning width; and
wherein a plurality of the effective contact portions configured by a plurality of the loop-like ends are formed in the entire cleaning width.

10. The image forming apparatus according to claim 6, wherein when the moving base is moved to a home position corresponding to one end of the discharge wire, the moving base is positioned away from the grid so that the loop-like end is positioned away from or in point contact with the grid.
